(19) United States
(12) Patent Application Publication
(10) Pub. No.: US 2025/0223212 A1
(43) Pub. Date: Jul. 10, 2025

(54) METHODS AND RELATED APPARATUS FOR PROCESSING BIOSOLIDS

(71) Applicant: Brown and Caldwell, Walnut Creek, CA (US)

(72) Inventors: Kenny KLITTICH, San Diego, CA (US); Ric TRAEGER, Peoria, AZ (US)

(73) Assignee: Brown and Caldwell, Walnut Creek, CA (US)

(21) Appl. No.: 18/701,767

(22) PCT Filed: Dec. 16, 2022
(86) PCT No.: PCT/US2022/053191

§ 371 Date: Apr. 16, 2024

Related U.S. Application Data
(60) Provisional application No. 63/265,594, filed on Dec. 17, 2021.
(60) Provisional application No. 63/432,502, filed on Dec. 14, 2022.

(51) Int. Cl. C02F 11/13; C02F 101/30

(52) U.S. Cl. CPC C02F 11/13; C02F 2101/30; C02F 2209/02

(57) ABSTRACT

Methods of biosolids processing disclosed herein may be configured in a two-stage process. The methods include the step of distributing biosolids in an input state onto a first thermal floor disposed within a first greenhouse, the first thermal floor adapted to transfer heat to the biosolids from a working fluid communicated through the first thermal floor thereby transforming the biosolids from the input state into a first processed state at a first stage of the two-stage process. The method includes the step of distributing the biosolids in the first processed state onto a second thermal floor disposed within a second greenhouse and then heating the biosolids thereby transforming the biosolids from the first processed state into a second processed state at a second stage of the two-stage process by heating the biosolids. Apparatus that functions to implement the methods are also disclosed.

### BACKGROUND OF THE INVENTION

### Field

The present application relates to processing biosolids produced by wastewater treatment processes, in particular to produce biosolids meeting certain standards.

### Background

Wastewater treatment plants produce and must dispose of residual solids collected as part of the wastewater treatment process (known as biosolids or sludge). Many wastewater treatment plants haul biosolids by truck to be land applied or landfilled, and generally pay for both the hauling and the disposal by weight of the biosolids.

Mechanical dewatering processes may typically produce biosolids having total solids (TS) generally in a range of from about 15% to about 25%. Clearly, in this range of TS, the majority of the biosolids weight is due to water. Hauling this water adds significantly to the cost of disposal of the biosolids. Technologies that can further remove water from biosolids can significantly reduce disposal costs and well as reduce hauling environmental impacts.

In addition, treatment of biosolids to certain standards may allow for certain uses of the biosolids alternative to landfill disposal. For example, the United States Environmental Protection Agency (USEPA) defines the microbiological loading that is acceptable for unrestricted use of biosolids following treatment. As defined by the USEPA, there are several classes of produced biosolids ranging in quality and acceptable use. For example, Class A biosolids may be used as a soil amendment or fuel. Class A biosolids require a greater level of treatment to reduce the microbial population than Class B biosolids. However, Class A biosolids have more uses than Class B biosolids. This includes marketing the product as a soil amendment. Biosolids treated to Class A standard are defined by 40 Code of Federal Regulations (CFR) Part 503, Standards for the Use of Disposal of Sewage Sludge. Biosolids meeting Class A requirement may have utility and corresponding economic value that may provide a revenue stream, not just a disposal cost.

Accordingly, there is a need for improved methods and related apparatus for treating biosolids.

### BRIEF SUMMARY OF THE INVENTION

These and other needs and disadvantages may be overcome by the methods and apparatus disclosed herein. Additional improvements and advantages may be recognized by those of ordinary skill in the art upon study of the present disclosure.

Method of biosolids processing disclosed herein may be configured in a two-stage process, in various aspects. The methods include the step of distributing biosolids in an input state onto a first thermal floor first end of a first thermal floor disposed within a first greenhouse, the first thermal floor adapted to transfer heat to the biosolids from a working fluid communicated through the first thermal floor, and the step of transforming the biosolids from the input state into a first processed state at a first stage of said two-stage process by heating the biosolids to a first temperature T₁ for first detention time D₁ within the first greenhouse while transferring the biosolids from the first thermal floor first end of the first thermal floor to a first thermal floor second end of the first thermal floor, in various aspects. The method disclosed herein may include the step of distributing the biosolids in a first processed state onto a second thermal floor disposed within a second greenhouse, the second thermal floor adapted to transfer heat to the biosolids from the working fluid communicated through the second thermal floor. The method disclosed herein may include the step of transforming the biosolids from the first processed state into a second processed state at a second stage of said two-stage process by heating the biosolids to a second temperature T₂ for second detention time D₂ within the second greenhouse.

In various aspects, biosolids processing apparatus is configured as a two-stage process. The biosolids processing apparatus includes a first thermal floor disposed within a first greenhouse to define a first thermal floor first end and a first thermal floor second end, with the first thermal floor adapted to transfer heat to the biosolids from a working fluid communicated through the first thermal floor to transform the biosolids from an input state proximate the first thermal floor first end into a first processed state proximate the first thermal floor second end in a first stage of said two-stage process, in various aspects. The biosolids processing apparatus includes a second thermal floor disposed within a second greenhouse to define a second thermal floor first end and a second thermal floor second end, and the second thermal floor adapted to transfer heat to the biosolids from the working fluid communicated through the second thermal floor to transform the biosolids from the first processed state into a second processed state in a second stage of said two-stage process, in various aspects. The biosolids are heated to a first temperature T₁ for a first detention time D₁ within the first greenhouse, and the biosolids are heated to a second temperature T₂ for a second detention time D₂ within the second greenhouse, in various aspects.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1 illustrates by schematic diagram an exemplary biosolids processing apparatus including material flows through the exemplary biosolids drying apparatus;

FIG. 2 illustrates by cut-away perspective view portions of the exemplary biosolids processing apparatus of FIG. 1;

FIG. 3 illustrates by cut-away perspective view portions of the exemplary biosolids processing apparatus of FIG. 1;

FIG. 4 illustrates by perspective view portions of the exemplary biosolids processing apparatus of FIG. 1;

FIG. 5 illustrates by cut-away perspective view portions of the exemplary biosolids processing apparatus of FIG. 1;

FIG. 6A illustrates by cut-away perspective view portions of the exemplary biosolids processing apparatus of FIG. 1;

FIG. 6B illustrates by cross-sectional view portions of the exemplary biosolids processing apparatus of FIG. 1;

FIG. 7 illustrates by process flow chart an exemplary process of drying biosolids as may be implemented using the exemplary biosolids processing apparatus of FIG. 1; and,

FIG. 8 illustrates by schematic diagram an implementation of the exemplary process of FIG. 7 implemented using the exemplary biosolids processing apparatus of FIG. 1 as set forth in Example 1.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure.

### DETAILED DESCRIPTION OF THE INVENTION

Methods and related apparatus for biosolids processing are disclosed herein. In various aspects, the methods are implemented using a two-stage process wherein a first greenhouse and a second greenhouse comprise the first stage and the second stage of the two-stage process, respectively, with the first stage (e.g., first greenhouse) being continuous generally plug flow process. The second stage (e.g., second greenhouse) may be configured as either a continuous plug flow process, a batch process, or a combination continuous flow and batch process, in various aspects. The methods and related biosolids process apparatus may be sized and operated to output biosolids from the second stage in a second processed state meeting a standard, in various aspects. For example, the standard for biosolids in the second processed state may be given as water content of the biosolids so that total solids (TS) equals or exceeds a TS standard. Note that TS is given in percent by weight herein unless otherwise indicated. As another example, the standard for biosolids in the second processed state may meet a microbial population standard such as given in the USEPA Class A standard. Biosolids output from the first stage in first processed state may also meet a TS standard or microbial population standard, such as given in the USEPA Class B standard, in various aspects. In certain aspects, the process may comprise only a single stage such as either first greenhouse or second greenhouse.

In various aspects, the methods include distributing biosolids in an input state onto a first thermal floor first end of a first thermal floor disposed within the first greenhouse and heating the biosolids by heating the first thermal floor using a working fluid while transferring the biosolids from the first thermal floor first end of the first thermal floor to a first thermal floor second end of the first thermal floor thereby transforming the biosolids from the input state at the first thermal floor first end to a first processed state at the first thermal floor second end. In various aspects, the methods include distributing biosolids in the first processed state, as output from the first greenhouse, onto a second thermal floor first end of a second thermal floor disposed within the second greenhouse, and heating the biosolids by heating the second thermal floor using the working fluid. In some aspects, the biosolids are distributed across at least portions of the second thermal floor, heated, and then removed, so that the second greenhouse is operated, at least in part, as a batch process. In other aspects, the biosolids are heated while being transferring continuously from the second thermal floor first end of the second thermal floor to a second thermal floor second end of the second thermal floor thereby transforming the biosolids from the first processed state at the second thermal floor first end to a second processed state at the second thermal floor second end, thereby operating the second greenhouse as a continuous flow process. In still other aspects, the first thermal floor and/or the second thermal floor may be subdivided into two or more floor regions with each floor region being variously operated as a batch or continuous flow process. Thus, for example, portions of the second thermal floor of the second greenhouse may be operated as a continuous flow process while other portions of the second thermal floor of the second greenhouse are operated as a batch process so that the second greenhouse encompass both continuous flow and batch processes. In various aspects, the methods include outputting biosolids in the second processed state from the second greenhouse. In various aspects, the methods include heating the working fluid using solar energy collected by a solar collector.

According to the USEPA as set forth in 40 CFR 503.32, the Class A standard is met when the percent solids of the sewage sludge is seventy-five percent or higher for digested sludge and ninety percent or higher for non-digested sludge, the temperature of the sewage sludge shall be 50 degrees Celsius or higher; the time period shall be 20 minutes or longer; and the temperature and time period shall be determined using [equation (1) below], except when small particles of sewage sludge are heated by either warmed gases or an immiscible liquid

$$D = \frac{131 , 700 , 000}{{10}^{0.14 T}} \qquad ( 1 )$$

where detention time D=time in days and temperature T=temperature in degrees Celsius. Note that the 40 CFR 503.32 standard requires T≥50° C. and D≥20 min/1440 min/day=0.0139 day. According to the Class A standard, the water content is reduced to TS of at least 75% for digested sludge and 90% for non-digested sludge. Testing must show that either fecal coliform is below 1,000 Most Probable Number (MPN) per gram of dry solids, or Salmonella is measured at less than 3 MPN/4 g of dry solids. Pathogens should be below detectable limits 24 hours after treatment or at the point of application. Class A should not exceed limits for As, Cd, Cr, Co, Pb, Hg, Mo, Ni, Se, Zn. At least 38% reduction in volatile solids should be observed.

According to the USEPA as set forth in 40 CFR 503.32 (b), the Class B standard requires that seven representative samples of the biosolids that are used or disposed shall be collected. The geometric mean of the density of fecal coliform in the samples collected shall be less than either 2,000,000 MPN/g of total solids (dry weight basis) or 2,000,000 Colony Forming Units (CFU) per gram of total solids (dry weight basis). Class B biosolids should not exceed limits for As, Cd, Cr, Co, Pb, Hg, Mo, Ni, Se, Zn.

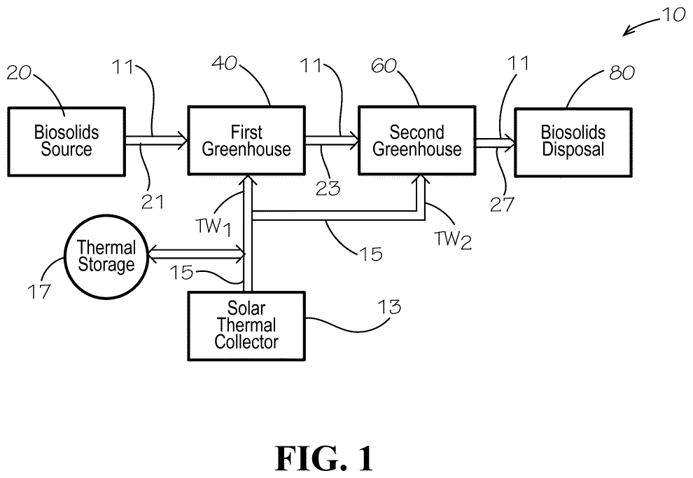

As illustrated in FIG. 1, exemplary biosolids processing apparatus 10 includes biosolids source 20, first greenhouse 40, second greenhouse 60, and biosolids disposal 80. Biosolids 11 are sequentially communicated from biosolids source 20 through first greenhouse 40, second greenhouse 60, and, thence, to biosolids disposal 80, as illustrated. Biosolids 11 are communicated into first greenhouse 40 from biosolids source 20 in input state 21. Biosolids 11 are communicated from first greenhouse 40 to second greenhouse 60 in first processed state 23, as illustrated. Biosolids 11 are communicated from second greenhouse 60 to biosolids disposal 80 in second processed state 27, as illustrated. Thus, in this implementation, biosolids 11 are processed in a two-stage process wherein first greenhouse 40 processes biosolids 11 from input state 21 to first processed state 23 and second greenhouse 60 processes biosolids 11 from first processed state 23 to second processed state 27. Although first greenhouse 40 and second greenhouse 60 are presented as single greenhouse structures for explanatory purposes in this exemplary implementation, it should be recognized that first greenhouse 40 and second greenhouse 60 may each be configured as multiple greenhouse structures with the multiple greenhouse structures operated in parallel or in sequence with one another, in various other implementations.

As illustrated in FIG. 1, exemplary biosolids processing apparatus 10 further includes solar collector 13 including other thermal source(s) and thermal storage 17. Working fluid 15 communicates between solar collector 13 that heats working fluid 15, thermal storage 17, and first greenhouse 40 and second greenhouse 60 that are heated by working fluid 15, as illustrated. Working fluid 15 may, for example, include water, various organic fluids such as oil(s), and combinations thereof, as would be readily recognized by those of ordinary skill in the art upon study of this disclosure. Working fluid 15 comprised of oil may, for example, be heated to a temperature generally between about 200° F. (93° C.) and 600° F. (316° C.) by solar collector 13 and stored in thermal storage 17. Working fluid 15 comprised of water may, for example, be heated to a temperature generally between about 150° F. (66° C.) and 300° F. (180° C.) by solar collector 13 and stored in thermal storage 17. Working fluid 15 is communicated to first greenhouse 40 at first working fluid temperature TW₁ and working fluid 15 is communicated to second greenhouse 60 at second working fluid temperature TW₂, as illustrated in FIG. 1.

Biosolids source 20 may receive biosolids and process biosolids including dewatering biosolids, such as biosolids 11, variously generated by secondary biological processes used in wastewater treatment such as an activated sludge process. In various implementations, biosolids source 20 may include sludge thickener(s), sludge digester(s), centrifuge(s), along with pump(s), piping, controls, and so forth, as would be readily understood by those of ordinary skill in the art upon study of this disclosure.

In various implementations, solar collector 13 may be formed according to any commercially available concentrating solar thermal collector technology, including parabolic dish or trough configured to heat working fluid 15 using solar energy. An exemplary solar collector 13 is the one axis parabolic solar concentrator model S20 manufactured by Rackam of Valcourt, QC, Canada. As used herein, solar collector 13 further includes non-solar energy sources such as a heat pump, a combustion heater, a resistive heater, an apparatus for heat recovery from cogeneration systems, an apparatus for waste heat recovery, and so forth, and combinations thereof, as may be used to provide heat or heating as operating conditions may necessitate (e.g., when solar energy is not available).

Thermal storage 17 may be formed as an insulated tank with low-velocity quiescent upper and lower fluid manifolds to promote thermocline layer and thermal stratification to contain working fluid 15 until working fluid 15 is required for heating first greenhouse 40 and second greenhouse 60. Working fluid 15 communicates between solar collector 13, thermal storage 17, first greenhouse 40 and second greenhouse 60, as illustrated. Solar collector 13 in combination with thermal storage 17, first greenhouse 40 and second greenhouse 69 may include various fluid pathways, heat exchanger(s), pump(s), gauges, fluid controls, and so forth, that cooperate operatively with the fluid pathways communicating working fluid 15, as would be readily recognized by those of ordinary skill in the art upon study of this disclosure. While FIG. 1 illustrates working fluid 15 as being communicated from solar collector 13 to thermal storage 17 and thence to first greenhouse 40 and second greenhouse 60, it should be recognized that working fluid 15 may be recirculated at least in part, in various implementations. Such recirculation is not included for clarity of explanation. Furthermore, it should be recognized that working fluid 15 being communicated between solar collector 13, thermal storage 17, first greenhouse 40 and second greenhouse 60 may have differing compositions, temperatures, or differing compositions and temperatures, in various implementations. For example, working fluid 15 comprised of organic fluid may be communicated between solar collector 13 and thermal storage 17 while working fluid 15 comprised of water may be communicated between thermal storage 17 and first greenhouse 40 and second greenhouse 60 with the organic fluid exchanging heat with the water via a heat exchanger.

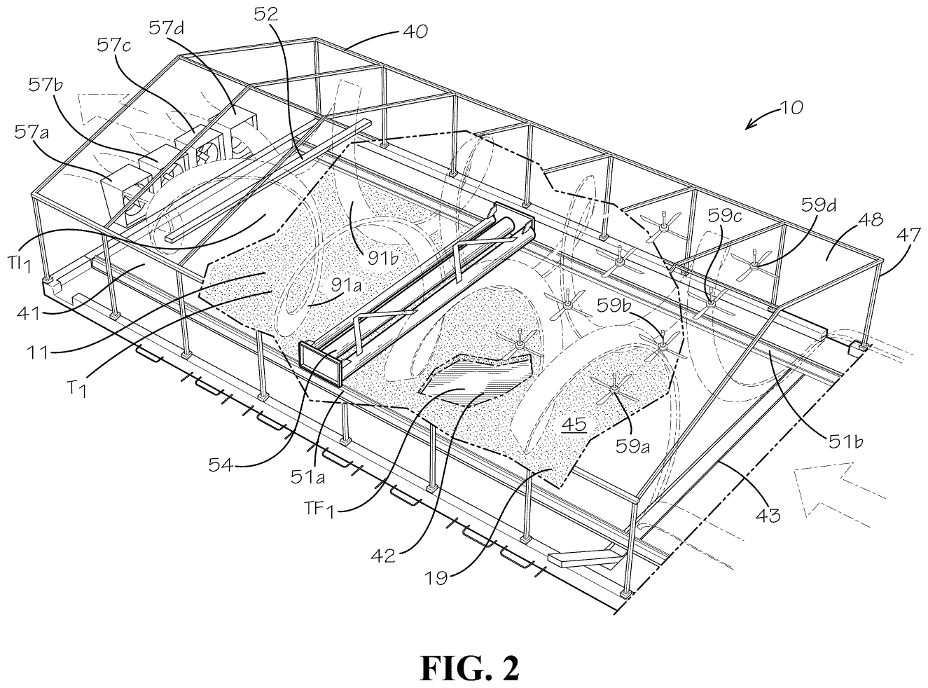

FIG. 2 illustrates first greenhouse 40. As illustrated in FIG. 2, first greenhouse 40 is formed in part as framework 47 to which panels, such a panels 48, are attached to generally enclose first greenhouse interior 45 including first thermal floor 42. Framework 47 may be formed of steel structural members. Panels, such as panels 48, may be formed of glass or plastic with each panel enclosing only a portion of first greenhouse interior 45. In some implementations, panel(s), such as panels 48, may comprise plastic sheeting that may engage framework 47 to enclose first greenhouse interior 45. The panels, such as panel 48, may be transparent to allow influx of solar radiation through the panels into first greenhouse interior 45. Solar radiation through the panels, such as panels 48, may, at least in part, heat first greenhouse interior 45 to first interior temperature TI₁.

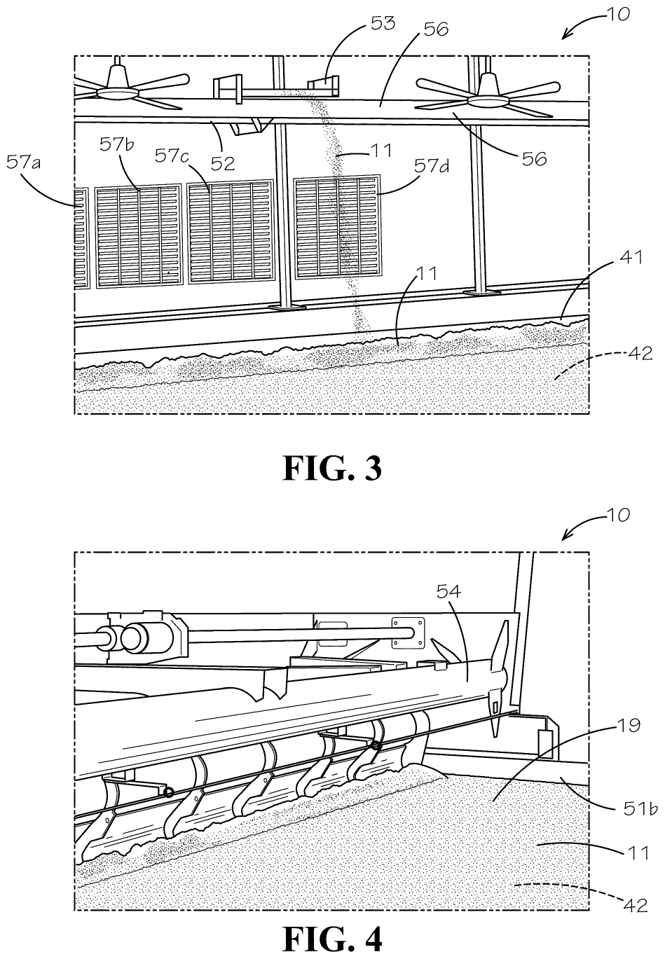

First thermal floor 42 defines first thermal floor first end 41 and first thermal floor second end 43 that lie within first greenhouse interior 45. First biosolids distributor 52 is located proximate first thermal floor first end 41, as illustrated. First biosolids distributor 52 is configured to distribute biosolids 11 onto first thermal floor 42 proximate first thermal floor first end 41. First biosolids distributor 52 is illustrated in general in FIG. 2 with details illustrated in FIG. 3 for clarity of explanation. First thermal floor 42 is heated to first thermal floor temp TF₁ by working fluid 15 at first working fluid temperature TW₁ to heat, at least in part, biosolids 11 disposed upon first thermal floor 42 to first temperature T₁. Heating of first thermal floor 42 may, at least in part, heat first greenhouse interior 45 to first interior temperature TI₁.

First biosolids handler 54 is mounted moveably to rails 51a, 51b that extend generally between first thermal floor first end 41 and first thermal floor second end 43 to allow traversal of first biosolids handler 54 on rails 51a, 51b generally between first thermal floor first end 41 and first thermal floor second end 43. First biosolids handler 54 may be traversed in other ways, in various other implementations. First biosolids handler 54 is configured to mix biosolids 11 as biosolids 11 are transferred by first biosolids handler 54 from first thermal floor first end 41 to first thermal floor second end 43 while disposed upon first thermal floor 42. An exemplary first biosolids handler 54 is the Solstice Sludge Turner available from Huber SE of Berching, Germany.

One or more exhaust fans, such as exhaust fan 57a, 57b, 57c, 57d, are disposed generally proximate first thermal floor first end 41 to draw ambient air into first greenhouse interior 45 from the exterior environment proximate first thermal floor second end 43, as illustrated in FIG. 2. Various numbers of exhaust fans, such as exhaust fan 57a, 57b, 57c, 57d, may be provided, in various implementations. Ambient air then passes over biosolids 11 disposed upon first thermal floor 42 from first thermal floor second end 43 to first thermal floor first end 41 and, thence, through exhaust fans 57a, 57b, 57c, 57d into the ambient environment to dry biosolids 11 disposed upon first thermal floor 42, as illustrated. Air may pass from exhaust fans 57a, 57b, 57c, 57d through odor control processes (not shown) before being exhausted into the ambient environment, in various implementations. As illustrated, ceiling fans, such as ceiling fans 59a, 59b, 59c, 59d, are disposed about upper portions of first greenhouse interior 45 to force air downward onto biosolids 11 disposed upon first thermal floor 42. Various numbers of ceiling fans, such as ceiling fans 59a, 59b, 59c, 59d, may be provided, in various implementations.

FIG. 3 illustrates first biosolids distributor 52 located above first thermal floor 42 to distribute biosolids 11 in input state 21 upon first thermal floor 42 proximate first thermal floor first end 41. In this implementation, member 56 remains in a stationary location with respect to first thermal floor 42 proximate first thermal floor first end 41 and generally parallel to first thermal floor first end 41, while plow 53 traverses member 56 longitudinally back and forth to distribute biosolids 11 generally evenly across first thermal floor 42 in a windrow proximate first thermal floor first end 41 by plowing biosolids 11 off of a conveyor (not shown) that cooperates with member 56 and plow 53, as illustrated. An exemplary first biosolids distributor 52 is the model 1605 available from Patz Corp. of Pound, WI.

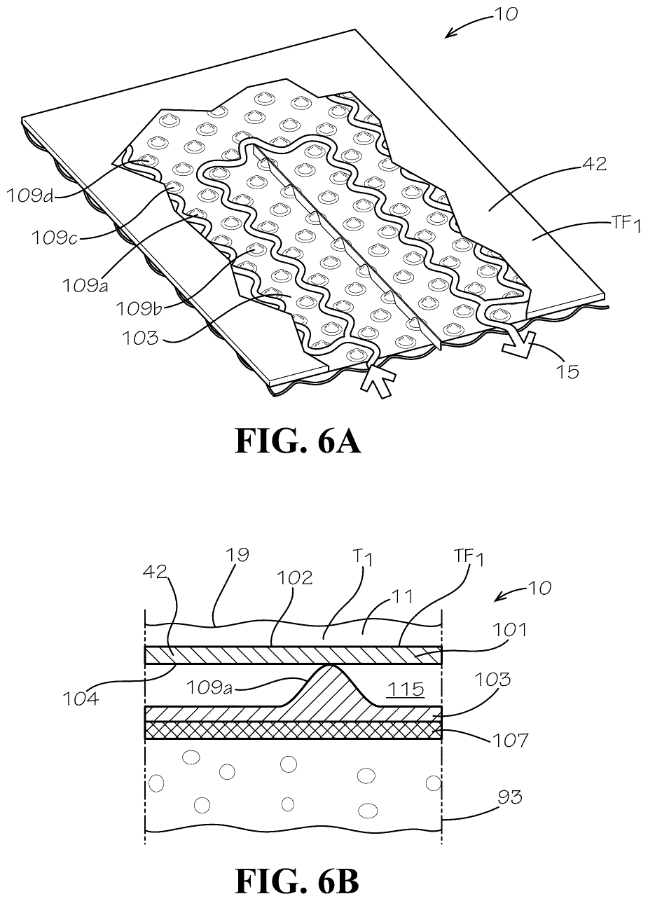

FIG. 4 illustrates portions of first biosolids handler 54 including rail 51b to which first biosolids handler 54 is moveably mounted. In this exemplary implementation, first biosolids handler 54 is configured as two open half-cylinders that extend across first thermal floor 42 generally parallel to first thermal floor first end 41 and are rotatably mounted to an axle. As the axle is rotated, the open half-cylinders scoop up and then release biosolids 11 to mix and traverse biosolids 11. Such mixing by first biosolids handler 54 may break up clumps and clods of biosolids 11, mix biosolids 11, and variously reposition portions of biosolids 11 between first thermal floor 42 and surface 19 of biosolids 11 (also see FIGS. 2, 6B) in order to enhance heating and drying of biosolids 11. Longitudinal movement of first biosolids handler 54 along rails during axial rotation traverses biosolids 11 from first thermal floor first end 41 to first thermal floor second end 43 as biosolids 11 are being mixed, in this implementation.

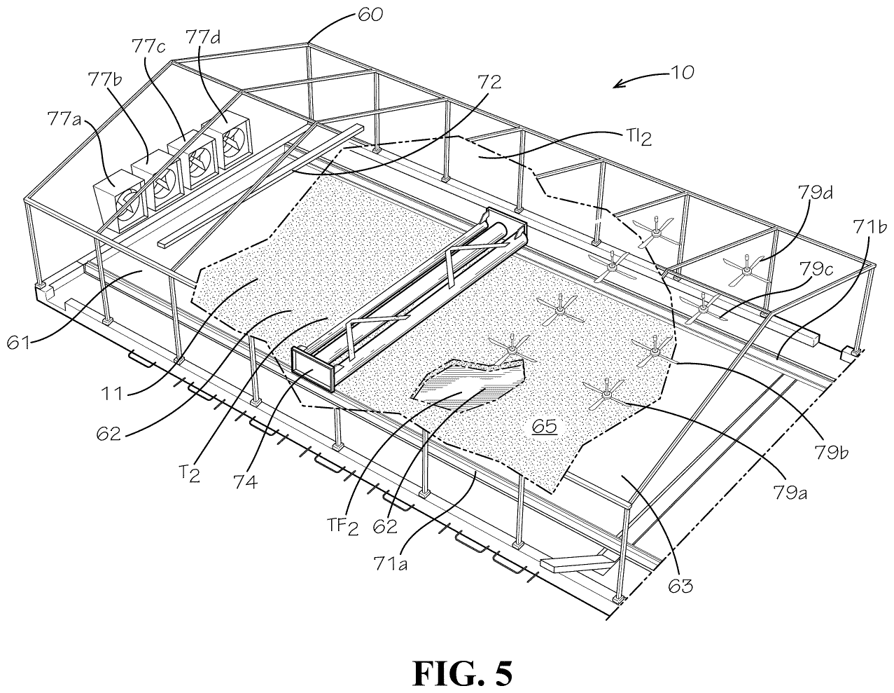

FIG. 5 illustrates second greenhouse 60 with second greenhouse 60 being configured similarly to first greenhouse 40. As illustrated in FIG. 5, second thermal floor 62 defines second thermal floor first end 61 and second thermal floor second end 63 within second greenhouse interior 65. Second biosolids distributor 72, which is configured similarly to first biosolids distributor 52 illustrated in FIG. 3, is located proximate second thermal floor first end 61, as illustrated in FIG. 5. Details of second biosolids distributor 72 are omitted in FIG. 5 for clarity of explanation. Second biosolids distributor 72 is configured to distribute biosolids 11 onto second thermal floor 62 in a windrow proximate second thermal floor first end 61. Second biosolids handler 74 is mounted moveably to rails 71a, 71b that extend generally between second thermal floor first end 61 and second thermal floor second end 63 to allow traversal of second biosolids handler 74 on rails 71a, 71b generally between second thermal floor first end 61 and second thermal floor second end 63. Second biosolids handler 74 mixes biosolids 11 and transfers biosolids 11 about second thermal floor 62. Second biosolids handler 74 is configured similarly to first biosolids handler 54, in this implementation.

Second thermal floor 62 is heated to second thermal floor temp TF₂ by working fluid 15 at second working fluid temperature TW₂ to heat, at least in part, biosolids 11 disposed upon second thermal floor 62 to second temperature T₂. Solar radiation may heat second greenhouse interior 65, at least in part, to second interior temperature TI₂. First thermal floor temperature TF₁ and second thermal floor temperature TF₂ may, at least in part, generally maintain first greenhouse interior 45 at first interior temperature TI₁ and maintain second greenhouse interior 65 at second interior temperature TI₂, respectively.

One or more exhaust fans, such as exhaust fans 77a, 77b, 77c, 77d, are disposed generally proximate second thermal floor first end 61 to draw ambient air into second greenhouse interior 65 from the exterior environment proximate second thermal floor second end 63. Ambient air then passes over biosolids 11 from second thermal floor second end 63 to second thermal floor first end 61 and, thence, through exhaust fans 77a, 77b, 77c, 77d into the ambient environment to dry biosolids 11 disposed upon second thermal floor 62, as illustrated. Air from second greenhouse interior 65 may pass from exhaust fans 77a, 77b, 77c, 77d through an odor control apparatus before being exhausted into the ambient environment, in various implementations. As illustrated, ceiling fans, such as ceiling fans 79a, 79b, 79c, 79d are disposed about upper portions of second greenhouse interior 65 to force air downward onto biosolids 11 disposed upon second thermal floor 62.

FIGS. 6A, 6B illustrate first thermal floor 42. Second thermal floor 62 is formed similarly to first thermal floor 42 and second thermal floor 62 functions similarly to first thermal floor 42, in this implementation. As illustrated in FIGS. 6A, 6B, first thermal floor 42 includes substantially planar upper layer 101 that rests upon projections, such as projections 109a, 109b, 109c, 109d formed in substantially planar lower layer 103 so that, apart from the projections, upper layer 101 is disposed in gapped relation with lower layer 103 thereby defining gap 115 between upper layer 101 and lower layer 103, in this implementation. Upper layer 101 and lower layer 103 are preferably formed from the same material, preferably aluminum, steel, or stainless steel. Working fluid 15 may be communicated through gap 115 to transfer heat through upper layer 101 to biosolids 11 disposed upon surface 102 of upper layer 101. Surface 104 of upper layer 101 contacts working fluid 15 other than at locations where surface 104 of upper layer 101 contacts projections, such as projections 109a, 109b, 109c, 109d, to allow heat transfer from working fluid through upper layer 101 from surface 104 to surface 102 and, thence, to biosolids 11 disposed upon surface 102. Surface 102 is generally heated to first thermal floor temperature TF₁, and biosolids 11 disposed upon surface 102 are thereby heated to first temperature T₁. First thermal floor temperature TF₁ may have an upper limit of about 500° F. (260° C.), in various implementations. As illustrated in FIG. 6A, projections, such as projections 109a, 109b, 109c, 109d, may cause working fluid 15 to follow a circuitous path as working fluid is communicated through gap 115, which may also enhance heat transfer from working fluid 15 to biosolids 11 through upper layer 101. As illustrated, insulation layer 107 is disposed between lower layer 103 and underlayment 93 to inhibit heat transfer from working fluid 15 through lower layer 103 to underlayment 93. Underlayment 93 may be, for example, concrete, aggregate, or compacted soil. Insulation layer 107 may, for example, be comprised of structural foam, radiant barrier, or fiberglass to prevent heat transfer through lower layer 103 to underlayment 93.

In operation, biosolids 11 in input state 21 (see Table 1 below) are communicated from biosolids source 20 to first greenhouse 40, and then distributed onto first thermal floor first end 41 of first thermal floor 42 within first greenhouse 40 using first biosolids distributor 52. Biosolids 11 in input state 21 may have TS content as indicated in Table 1 below. First biosolids handler 54 moves along rails transferring biosolids 11 from first thermal floor first end 41 to first thermal floor second end 43 while mixing biosolids 11. Working fluid 15 is heated by solar collector 13 and stored in thermal storage 17. Working fluid 15 at first working fluid temperature TW₁ (see Table 1) is then communicated from thermal storage 17 through gap 115 of first thermal floor 42 to heat biosolids 11 to first temperature T₁ (see Table 1) in order to evaporate water from biosolids 11 as biosolids 11 are being transferred from first thermal floor first end 41 to first thermal floor second end 43. Solar energy may also, in part, heat biosolids 11 to first temperature T₁ by radiation heat transfer and by contact with air within first greenhouse interior 45 heated by solar insolation to first interior temperature TI₁ (see Table 1) in order to evaporate water from biosolids 11 as biosolids 11 are being transferred from first thermal floor first end 41 to first thermal floor second end 43.

Ceiling fans, such as ceiling fans 59a, 59b, 59c, 59d, drive air at first interior temperature TI₁ within first greenhouse interior 45 downward onto surface 19 of biosolids 11 arrayed across first thermal floor 42 to evaporate water from biosolids 11. Exhaust fan(s), such as exhaust fan 57a, 57b, 57c, 57d, are operated intermittently in order to purge humid air from first greenhouse interior 45. Operation of the exhaust fans may be based on, for example, the interior and exterior air humidity and interior air temperature. The exhaust fans do not run continuously, in certain implementations. Operation of the exhaust fans may prioritize heat build-up within first greenhouse interior 45 followed by quickly purging humid air without removing more heat than necessary. Sensor(s) (not shown) may also trigger operation of the exhaust fans in order to limit gas concentration of undesirable gas to less than a specified gas concentration wherein undesirable gas includes, for example, H₂S and ammonia. As illustrated in FIG. 2, ceiling fans, such as ceiling fans 59a, 59b, 59c, 59d, and exhaust fans, such as exhaust fan 57a, 57b, 57c, 57d, may be operated to form a helical flow patterns 91a, 91b of air within first greenhouse interior 45 that may enhance evaporation of water from biosolids 11.

Because water is evaporated from biosolids 11 by heating of biosolids 11 and by forced air convection by ceiling fans 59a, 59b, 59c, 59d and exhaust fan 57a, 57b, 57c, 57d as biosolids 11 are transferred from first thermal floor first end 41 to first thermal floor second end 43, biosolids 11 are in first processed state 23 when biosolids 11 reach first thermal floor second end 43.

Biosolids 11 in first processed state 23 have TS as indicated in Table 1. Biosolids 11 in first processed state 23 may meet Class B standard as defined by 40 Code of Federal Regulations (CFR) Part 503, Standards for the Use of Disposal of Sewage Sludge.

First detention time D₁ (see Table 1) is defined as the amount of time biosolids 11 are maintained proximate first temperature T₁ within first greenhouse 40, and first detention time D₁ may be generally equivalent to the time require for biosolids 11 to traverse first thermal floor 42 from first thermal floor first end 41 to first thermal floor second end 43. First thermal floor 42 may be sized and first biosolids distributor 52 operated to select first detention time D₁. First detention time D₁ and first temperature T₁ may be selected to produce a desired first processed state 23 of biosolids 11 given input state 21 of biosolids 11 entering first greenhouse 40. First thermal floor temperature TF₁ and first interior temperature TI₁ may be selected to produce the selected first temperature T₁ of biosolids 11. First working fluid temperature TW₁ may be selected to produce the selected first floor temperature TF₁.

Biosolids 11 in first processed state 23 are then communicated from first thermal floor second end 43 of first thermal floor 42 onto second thermal floor first end 61 of second thermal floor 62 within second greenhouse 60. Accordingly, biosolids 11 proximate second thermal floor first end 61 are generally in first processed state 23.

Working fluid 15 is then communicated from thermal storage 17 through a gap, such as gap 115, defined within second thermal floor 62 to heat biosolids 11 to a second temperature T₂ (see Table 1) as biosolids 11 are being transferred from second thermal floor first end 61 to second thermal floor second end 63. The second working fluid temperature TW₂ (see Table 1) of working fluid 15 and the second thermal floor temperature TF₂ (see Table 1) of second thermal floor 62 are configured to heat biosolids 11 to second temperature T₂ (see Table 1). Mixing of biosolids 11 by second biosolids handler 72 exposes an entirety of biosolids 11 to second thermal floor 62 thereby ensuring that an entirety of biosolids 11 is heated to second temperature T₂. Solar energy captured by second greenhouse 60 may also assist in heating biosolids 11 to second temperature T₂ and air within second greenhouse interior 65 heated by captured solar energy may evaporate water from biosolids 11. Biosolids 11 are maintained at second temperature T₂ for second detention time D₂ (see Table 1) so that at least second detention time D₂ is required to transfer biosolids 11 from second thermal floor first end 61 to second thermal floor second end 63. Biosolids 11 in second processed state 27 (see Table 1) are then communicated from second thermal floor second end 63 of second thermal floor 62 to biosolids disposal 80 for further processing and disposal.

Biosolids 11 in second processed state 27 have TS as indicated in Table 1. Second detention time D₂ is defined as the amount of time biosolids 11 are maintained proximate second temperature T₂ within second greenhouse 60, and second detention time D₂ may be generally equivalent to the time require for biosolids 11 to traverse second thermal floor 62 from second thermal floor first end 61 to second thermal floor second end 63. Second thermal floor 62 may be sized and second biosolids distributor 72 operated to select second detention time D₂. Second detention time D₂ and second temperature T₂ may be selected to produce a desired second processed state 27 of biosolids 11 from first processed state 23. Second thermal floor temperature TF₂ and second interior temperature TI₂ may be selected to produce the selected second temperature T₂ of biosolids 11. Second working fluid temperature TW₂ may be selected to produce the selected second floor temperature TF₂. Note that first detention time D₁ may or may not be equivalent to second detention time D₂, first temperature T₁ may or may not be equivalent to second temperature T₂, first floor temperature TF₁ may or may not be equivalent to second thermal floor temperature TF₂, first interior temperature TI₁ may or may not be equivalent to second interior temperature TI₂, and first working fluid temperature TW₁ may or may not be equivalent to second working fluid temperature TW₂, in various implementations. First detention time D₁, second detention time D₂, first temperature T₁, and second temperature T₂ may be selected to produce biosolids 11 with a desired second processed state 27 from biosolids 11 in input state 21 using first greenhouse 40 and second greenhouse 60 arranged in a two-stage process.

Biosolids disposal 80 may variously treat biosolids 11 in second processed state 27, may aggregate biosolids 11 in second processed state 27 in various containers for shipment, and may otherwise handle biosolids 11 in second processed state 27 in various ways, as would be readily understood by those of ordinary skill in the art upon study of this disclosure.

Second temperature T₂ and second detention time D₂ may be selected so that biosolids 11 in second processed state 27 meet various standards. For example, second temperature T₂ and second detention time D₂ may be selected so that biosolids 11 in second processed state 27 meet, for example, the Class A standard as defined by 40 Code of Federal Regulations (CFR) Part 503, Standards for the Use of Disposal of Sewage Sludge.

In addition, heating of biosolids 11 disposed upon second thermal floor 62 to second temperature T₂ may evaporate water from biosolids 11 as biosolids 11 are being transferred from second thermal floor first end 61 to second thermal floor second end 63. Ceiling fans, such as ceiling fans 79a, 79b, 79c, 79d, drive air at second interior temperature TI₂ within second greenhouse interior 65 downward onto a surface, such as surface 19, of biosolids 11 arrayed across second thermal floor 62 to evaporate water from biosolids 11, and exhaust fan(s), such as exhaust fan 77a, 77b, 77c, 77d, are operated intermittently in order to purge humid air from second greenhouse interior 65. Ceiling fans, such as ceiling fan 79a, 79b, 79c, 79d, and exhaust fans 77a, 77b, 77c, 77d of second greenhouse 60 may be operationally controlled similarly to ceiling fans, such as ceiling fans 59a, 59b, 59c, 59d, and exhaust fans 57a, 57b, 57c, 57d of first greenhouse 40 and may cooperate to form a helical flow pattern, such as helical flow pattern 91a, 91b, of air within second greenhouse interior 65. Exhaust fans 77a, 77b, 77c, 77d may discharge through various odor control processes (not shown) into the ambient environment.

Values for operational parameters cited above as used in various implementations of exemplary biosolids processing apparatus 10 are given in Table 1 below. Note that the values in Table 1 are approximate and exemplary. Conversions between units may be rounded.

TABLE 1

| Parameter | Minimum Value | | Exemplary Value | | Maximum Value | |
|---|---|---|---|---|---|---|
| First working fluid | 80° F. | (27° C.) | 160° F. | (71° C.) | Water 300° F. | |
| temperature TW₁ | | | | | (149° C.) | |
| | | | | | Oil 500° F. (260° C.) | |
| Second working fluid | 150° F. | (66° C.) | 180° F. | (71° C.) | Water 300° F. | |
| temperature TW₂ | | | | | (149° C.) | |
| | | | | | Oil 500° F. (260° C.) | |
| First thermal floor | 80° F. | (27° C.) | 160° F. | (71° C.) | 500° F. | (260° C.) |
| temperature TF₁ | | | | | | |
| Second thermal floor | 150° F. | (66° C.) | 180° F. | (71° C.) | 500° F. | (260° C.) |
| temperature TF₂ | | | | | | |
| First interior | 68° F. | (20° C.) | 100° F. | (38° C.) | 133° F. | (56° C.) |
| temperature TI₁ | | | | | | |
| Second interior | 68° F. | (20° C.) | 100° F. | (38° C.) | 133° F. | (56° C.) |
| temperature TI₂ | | | | | | |
| First temperature T₁ | 95° F. | (35° C.) | 135° F. | (57° C.) | 180° F. | (71° C.) |
| (of biosolids) | | | | | | |
| Second temperature T₂ | 145° F. | (63° C.)) | 155° F. | (68° C.) | 180° F. | (71° C.) |
| (of biosolids) | | | | | | |
| First detention time D₁ | 24 | hr | 36 | hr | 48 | hr |
| Second detention | 2.5 | hr | 3.0 | hr | 8.0 | hr |
| time D₂ | | | | | | |
| Input state TS | 14% | | 20% | | — | |
| First processed state TS | 75% | | 85% | | 95% | |
| Second processed | 90% | | 92% | | 95% | |
| state TS | | | | | | |
| Biosolids depth on first | 1 inch | (2.54 cm) | 5 inch | (12.7 cm) | 7 inch | (17.8 cm) |
| thermal floor | | | | | | |
| Biosolids depth on | 1 inch | (2.54 cm) | 2 inch | (5.1 cm) | 3 inch | (7.6 cm) |

| | | | |
|---|---|---|---|
| second thermal floor | | | |
| Process loading - first | 18 lb/sq-ft/day | — | 22 lb/sq-ft/day |
| thermal floor | (87.9 kg/m²/day) | | (107 kg/m²/day) |
| Process loading - | 3 lb/sq-ft/day | — | 10 lb/sq-ft/day |
| second thermal floor | (14.6 kg/m²/day) | | (48.8 kg/m²/day) |

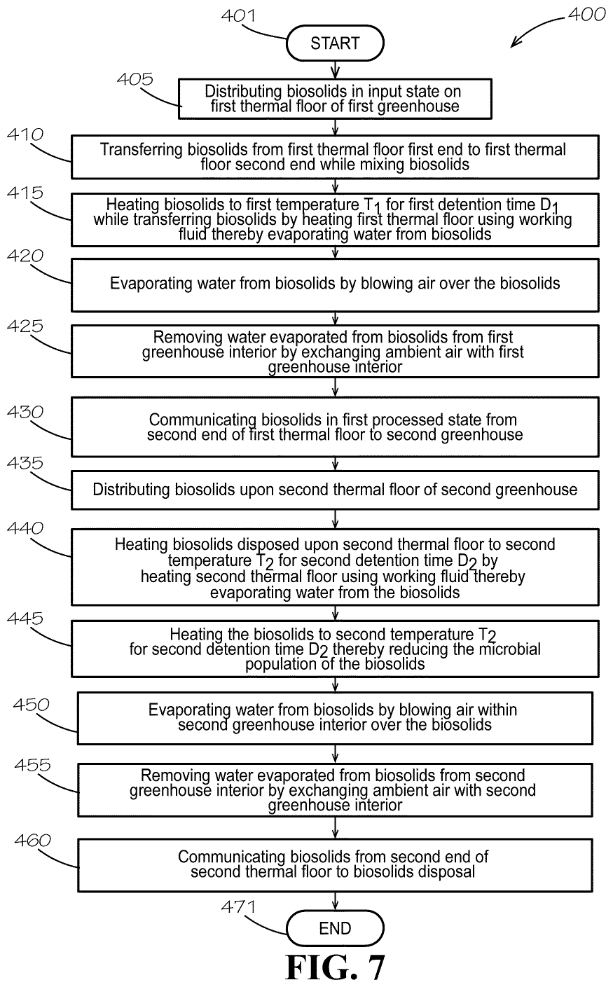

Exemplary process 400 illustrated in FIG. 7 may be implemented using exemplary biosolids processing apparatus 10. As illustrated in FIG. 7, process 400 is entered at step 401.

At step 405, biosolids in input state are distributed on first thermal floor of first greenhouse at first thermal floor first end.

At step 410, biosolids are transferred from first thermal floor first end to first thermal floor second end while biosolids are being mixed.

At step 415, the biosolids are being heated to first temperature T₁ for first detention time D₁ while being transferred by heating first thermal floor using working fluid thereby evaporating water from biosolids. The working fluid may be heated using a solar collector, and step 415 may be configured as a continuous flow process.

At step 420, water is evaporated from the biosolids by blowing air within first greenhouse interior over the biosolids while the biosolids are being transferred. Air within first greenhouse interior may be heated, at least in part, by solar energy captured within the first greenhouse.

At step 425, water evaporated from the biosolids is removed from the first greenhouse interior of the first greenhouse by exchanging air within the first greenhouse interior with the ambient environment. The biosolids are thus dried from input state to first processed state thereby increasing TS of the biosolids as the biosolids are transferred from first thermal floor first end to first thermal floor second end.

At step 430, biosolids in first processed state are communicated from the second end of the first thermal floor to the second greenhouse.

At step 435, the biosolids are distributed upon at least portions of the second thermal floor of the second greenhouse.

At step 440, the biosolids are heated to second temperature T₂ for second detention time D₂ at least in part by heating the second thermal floor using the working fluid thereby evaporating water from the biosolids and increasing the TS of the biosolids.

At step 445, the biosolids are heated to the second temperature T₂ for second detention time D₂, thereby reducing the microbial population within the biosolids. Second temperature T₂ and second detention time D₂ may be selected to cooperate to reduce the microbial population of the biosolids.

At step 450, water is evaporated from the biosolids by blowing air within second greenhouse interior over the biosolids. Air within second greenhouse interior may be heated, at least in part, by solar energy captured within the second greenhouse.

At step 455, water evaporated from the biosolids is removed from the second greenhouse interior by exchanging air within the second greenhouse interior with the ambient environment.

At step 460, the biosolids are communicated from the second end of the second thermal floor to biosolids disposal. Temperature T₂ and detention time D₂ may be selected to meet certain standards such as, for example, the Class A standard as set forth by USEPA.

Exemplary process 400 terminates at step 471.

### Example 1

In Example 1, exemplary process 400 is implemented using a specific exemplary implementation of biosolids processing apparatus 10. The values of various parameters used in Example 1 as presented in the following are, thus, exemplary and not limiting.

Biosolids 11 are distributed in windows upon first thermal floor 42 and second thermal floor 62 using biosolids distributors, such as first biosolids distributor 52 and second biosolids distributor 72. Biosolids 11 are mixed and/or transferred about first thermal floor 42 and second thermal floor 62 using one or more biosolids handlers, such as first biosolids handler 54 and second biosolids handler 74.

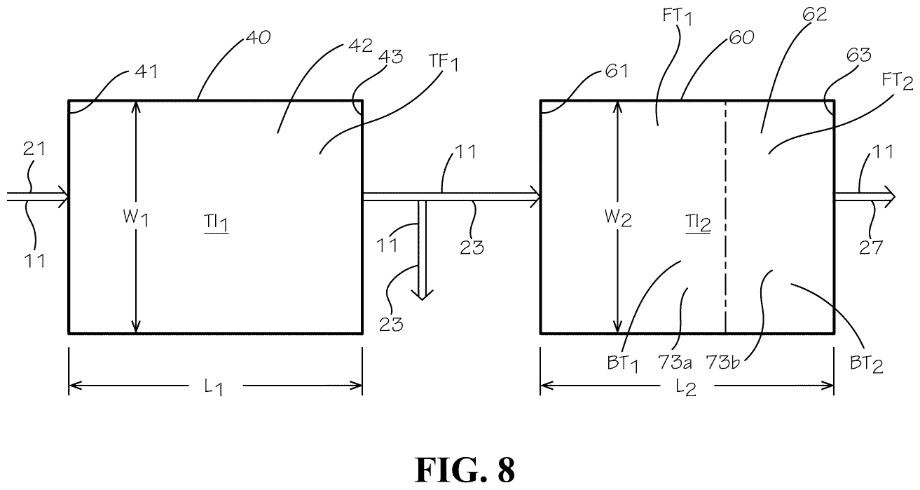

As illustrated in FIG. 8, portions of first thermal floor 42 of first greenhouse 40 available for processing biosolids 11 according to process 400 have width W₁ of approximately 37.5 ft (11.4 m) and length L₁ of approximately 400 ft (122 m) resulting in an area of approximately 15,000 sq ft (1,394 m²) available for processing biosolids 11. In various implementations, width W₁ may be generally in a range of from about 29.5 ft (9 m) to about 40 ft (12.2 m) and length L₁ may be generally in a range of from about 70 ft (21.3 m) to about 500 ft (152 m). Biosolids 11 enter first greenhouse 40 at in input state 21 having approximately 20% TS (by weight) and at a rate of up to about 4 wet ton/hour (3628 kg/hr). Thus, first thermal floor 42 is loaded continuously at approximately 19 lb/sq-ft/day (92.8 kg/m²/day) resulting in a first detention time D₁ in a range of approximately 24 to 36 hours.

The first thermal floor 42 is heated to a first thermal floor temperature TF₁ of approximately 180° F. (82° C.) and first interior temperature TI₁ is approximately 80° F. (27° C.). Biosolids 11 in first greenhouse 40 are thus heated to a first temperature T₁ of up to 110° F. (43° C.) for at least 52 minutes, in this example. Biosolids 11 leave first greenhouse 40 at first processed state 23 having approximately 80% TS and at a rate of up to about 24 wet ton/day (21,800 kg/day). In Example 1, biosolids 11 at first processed state 23 meet the Class B standard. Note that, per FIG. 8, a portion of biosolids 11 leaving first greenhouse 40 may be diverted, so that only non-diverted portions of biosolids 11 leaving first greenhouse 40 are then input into second greenhouse 60.

In Example 1, portions of second thermal floor 62 of second greenhouse 60 available for processing biosolids 11 according to process 400 have width W₂ approximately 37.5 ft (11.4 m) and length L₂ approximately 300 ft. (91.4 m) resulting in an area of 11,250 sq ft (1045 m²). Biosolids 11 are input into second greenhouse 60 in first processed state 23 at a rate of up to about 4 tons per hour (3628 kg/hr). Thus, second thermal floor 62 is loaded at approximately 25 lb/sq ft/day (122 kg/m²/day) resulting in a second detention time D₂ of up to about 240 min. The second interior temperature TI₂ is approximately 80° F. (27° C.), in Example 1.

In Example 1, second thermal floor 62 is divided into floor regions 73a, 73b. Biosolids 11 are distributed continuously at a generally even depth onto floor region 73a. Floor region 73a is heated to floor temperature FT₁ of approximately 200° F. (93.3° C.) thereby heating biosolids 11 to biosolids temperature BT₁ of 155° F. (68° C.). Biosolids 11 are then transferred from floor region 73a to floor region 73b and spread upon floor region 73b generally evenly at a depth of approximately 2 to 3 inches (5.1 cm to 7.62 cm) thick. The biosolids upon floor region 73b are then heated as a batch to biosolids temperature BT₂ of 155° F. (68° C.) for a second detention time D₂ of least 52 min (according to equation (1)) by heating floor region 73b to floor temperature FT₂ of approximately 200° F. (93.3° C.). Biosolids 11 are then entirely removed from floor region 73b and then output to biosolids disposal 80. Biosolids 11 are output from second greenhouse 60 at second processed state 27 having approximately 90% TS and at a rate of about 19 dry ton/day (17,200 kg/day). With floor region 73b cleared of biosolids 11, biosolids 11 are then transferred from floor region 73a onto floor region 73b and heated. Thus, both floor region 73a and floor region 73b of second thermal floor 62 are operated as a batch process. Positioning of biosolids 11 upon floor region 73a serves to preheat biosolids 11 prior to being heated on floor region 73b and provides storage that allows first greenhouse 40 to be operated as a continuous flow process. Biosolids 11 in second processed state 27 meet Class A standards.

Although floor temperature FT₁ of floor region 73a generally equals floor temperature FT₂ of floor region 73b in Example 1, floor temperature FT₁ of floor region 73a may differ from floor temperature FT₂ of floor region 73b, in other implementations. While biosolids temperature BT₁ generally equals biosolids temperature BT₂ in Example 1, biosolids temperature BT₁ may differ from biosolids temperature BT₂, in various other implementations. It should be understood that second thermal floor 62, may be divided into any number of floor regions, such as floor regions 73a, 73b, and each floor region may have a floor temperature, such as FT₁, FT₂, the biosolids upon each floor regions may have a corresponding biosolids temperature, such as BT₁, BT₂, and biosolids may be communicated with each floor region. Each floor region may be operated as either batch or continuous flow.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 40 C.F.R. § 1.72(b) only. Accordingly, the Abstract is not intended to identify key elements of the apparatus and methods disclosed herein or to delineate the scope thereof. Upon study of this disclosure and the exemplary implementations herein, one of ordinary skill in the art may readily recognize that various changes, modifications and variations can be made thereto without departing from the spirit and scope of the inventions as defined in the following claims.

1. A method of biosolids processing in a two-stage process, comprising the steps of:
distributing biosolids in an input state onto a first thermal floor first end of a first thermal floor disposed within a first greenhouse, the first thermal floor adapted to transfer heat to the biosolids from a working fluid communicated through the first thermal floor;
transforming the biosolids from the input state into a first processed state at a first stage of said two-stage process by heating the biosolids to a first temperature T₁ for first detention time D₁ within the first greenhouse while transferring the biosolids from the first thermal floor first end of the first thermal floor to a first thermal floor second end of the first thermal floor;
distributing the biosolids in the first processed state onto a second thermal floor disposed within a second greenhouse, the second thermal floor adapted to transfer heat to the biosolids from the working fluid communicated through the second thermal floor; and
transforming the biosolids from the first processed state into a second processed state at a second stage of said two-stage process by heating the biosolids to a second temperature T₂ for second detention time D₂ within the second greenhouse.

2. The method of claim 1, further comprising the step of:
transferring the biosolids from the second thermal floor first end of the second thermal floor to a second thermal floor second end of the second thermal floor while heating the biosolids to a second temperature T₂ for second detention time D₂.

3. The method of claim 1, further comprising the step of:
performing the step of transforming the biosolids from the first processed state into a second processed state by heating the biosolids to a second temperature T₂ for second detention time D₂ within the second greenhouse by operating the second greenhouse as a batch process.

4. The method of claim 1, further comprising the step of:
performing the step of transforming the biosolids from the first processed state into a second processed state by heating the biosolids to a second temperature T₂ for second detention time D₂ within the second greenhouse by operating the second greenhouse as a continuous flow process.

5. The method of claim 1, further comprising the step of:
performing the step of transforming the biosolids from the input state into a first processed state by heating the biosolids to a first temperature T₁ for first detention time D₁ within the first greenhouse while transferring the biosolids from the first thermal floor first end of the first thermal floor to a first thermal floor second end of the first thermal floor as a continuous flow process.

6. The method of claim 1, further comprising the step of:
mixing the biosolids while transferring the biosolids from the first thermal floor first end of the first thermal floor to the first thermal floor second end of the first thermal floor.

7. The method of claim 1, further comprising the step of:
evaporating water from the biosolids within the first greenhouse and within the second greenhouse at least in part using forced air convection having a helical flow pattern.

8. The method of claim 1, wherein the biosolids in the second processed state meet a standard selected from a total solids standard and a microbial population standard.

9. The method of claim 8, wherein the total solids standard requires a total solids of at least about 75% for digested biosolids and 90% for non-digested biosolids.

10. The method of claim 8, wherein the microbial population standard is selected from a group consisting of:
i) fecal coliform is below 1,000 MPN/g of dry solids;
ii) Salmonella is measured at less than 3 MPN/4 g of dry solids;
iii) less than 2,000,000 MPN/g of total solids (dry weight basis); and
iv) less than 2,000,000 CFU/g of total solids (dry weight basis).

11. The method of claim 1, further comprising the step of:
evaporating water from the biosolids at least in part by blowing air onto the biosolids while transferring the biosolids across the first thermal floor from the first thermal floor first end to the first thermal floor second end.

12. The method of claim 1, wherein at least one of the first thermal floor and the second thermal floor comprises an upper layer held in gapped relation with a lower layer by projections extending forth from the lower layer to define a gap between the upper layer and the lower layer and wherein the working fluid flows through the gap to heat the upper layer to a temperature less than about 500° F. (260° C.).

13. The method of claim 12, wherein the upper layer comprises a material selected from aluminum and steel.

14. (canceled)

15. A biosolids processing apparatus for a two-stage process, comprising:
a first thermal floor disposed within a first greenhouse to define a first thermal floor first end and a first thermal floor second end, the first thermal floor adapted to transfer heat to the biosolids from a working fluid communicated through the first thermal floor to transform the biosolids from an input state proximate the first thermal floor first end into a first processed state proximate the first thermal floor second end in a first stage of said two-stage process;
a second thermal floor disposed within a second greenhouse to define a second thermal floor first end and a second thermal floor second end, the second thermal floor adapted to transfer heat to the biosolids from the working fluid communicated through the second thermal floor to transform the biosolids from the first processed state into a second processed state in a second stage of said two-stage process; and
wherein the biosolids are heated to a first temperature T₁ for a first detention time D₁ within the first greenhouse and the biosolids are heated to a second temperature T₂ for a second detention time D₂ within the second greenhouse.

16. The apparatus of claim 15, wherein the biosolids in the second processed state meet a total solids standard, the total solids standard requiring a total solids of at least about 75%.

17. The apparatus of claim 15, wherein the biosolids in the second processed state meet a microbial population standard selected from a group consisting of:
i) fecal coliform is below 1,000 MPN/g of dry solids;
ii) Salmonella is measured at less than 3 MPN/4 g of dry solids;
iii) less than 2,000,000 MPN/g of total solids (dry weight basis); and
iv) less than 2,000,000 Colony Forming Units (CFU) per gram of total solids (dry weight basis).

18. The apparatus of claim 15, wherein at least one of the first thermal floor and the second thermal floor comprises an upper layer held in gapped relation with a lower layer by projections extending forth from the lower layer to define a gap between the upper layer and the lower layer and wherein the working fluid flows through the gap to heat the upper layer.

19. The apparatus of claim 18, wherein the upper layer comprises a material selected from aluminum and steel.

20. (canceled)

21. (canceled)

22. The apparatus of claim 15, further comprising:
mixing means for mixing the biosolids while transferring the biosolids from the first thermal floor first end of the first thermal floor to the first thermal floor second end of the first thermal floor.

23. A method of biosolids processing, comprising the steps of:
distributing biosolids in an input state onto a first thermal floor first end of a first thermal floor disposed within a greenhouse, the first thermal floor adapted to transfer heat to the biosolids from a working fluid communicated through the first thermal floor;
transforming the biosolids from the input state into a first processed state at a first stage of said method by heating the biosolids to a first temperature T₁ for a first detention time D₁ while transferring the biosolids from the first thermal floor first end of the first thermal floor to a first thermal floor second end of the first thermal floor; and
mixing the biosolids while transferring the biosolids from the first thermal floor first end of the first thermal floor to the first thermal floor second end of the first thermal floor.

24. The method of claim 23, further comprising the steps of:
distributing the biosolids in the first processed state onto a second thermal floor first end of a second thermal floor, the second thermal floor adapted to transfer heat to the biosolids from the working fluid communicated through the second thermal floor;
transforming the biosolids from the first processed state into a second processed state at a second stage of said method by heating the biosolids to a second temperature T₂ for a second detention time D₂ while transferring the biosolids from the second thermal floor first end of the second thermal floor to a second thermal floor second end of the second thermal floor;
mixing the biosolids while transferring the biosolids from the second thermal floor first end of the second thermal floor to the second thermal floor second end of the second thermal floor.

25. The method of claim 23, wherein the first thermal floor comprises a substantially planar upper layer held in gapped relation with a substantially planar lower layer by projections extending between the upper layer and the lower layer to define a gap between the upper layer and the lower layer and wherein the working fluid flows through the gap to heat the upper layer.

26. The method of claim 24, wherein at least one of the first thermal floor and the second thermal floor comprises a substantially planar upper layer held in gapped relation with a substantially planar lower layer by projections extending between the upper layer and the lower layer to define a gap between the upper layer and the lower layer and wherein the working fluid flows through the gap to heat the upper layer.
